(19) United States
(12) Patent Application Publication
(10) Pub. No.: US 2024/0310716 A1
(43) Pub. Date: Sep. 19, 2024

(54) PROJECTOR

(71) Applicant: SEIKO EPSON CORPORATION, Tokyo (JP)

(72) Inventor: Norio NAKAMURA, Matsumoto-shi (JP)

(73) Assignee: SEIKO EPSON CORPORATION, Tokyo (JP)

(21) Appl. No.: 18/602,821

(22) Filed: Mar. 12, 2024

(30) Foreign Application Priority Data
Mar. 13, 2023 (JP) 2023-038659

(51) Int. Cl. G03B 41/00; G03B 21/00; G03B 21/20; G03B 21/28

(52) U.S. Cl. CPC G03B 41/00; G03B 21/006; G03B 21/2066; G03B 21/208; G03B 21/28

(57) ABSTRACT

A projector of the present disclosure includes a light source outputting a light, one liquid crystal panel modulating the light output from the light source based on an image signal, a polarizer reflecting a first light as a first polarization component generating an image light of the light output from the liquid crystal panel, and transmitting a second light as a second polarization component different from the first polarization component of the light output from the liquid crystal panel, and a first solar cell entered by the second light as the second polarization component transmitted through the polarizer, wherein the first solar cell generates electricity from the second light as the second polarization component entering from the polarizer.

The present application is based on, and claims priority from JP Application Serial Number 2023-038659, filed Mar. 13, 2023, the disclosure of which is hereby incorporated by reference herein in its entirety.

### BACKGROUND

### 1. Technical Field

The present disclosure relates to a projector.

### 2. Related Art

JP-A-09-101495 discloses a single-LCD projector including a light source, one liquid crystal panel, a first polarizer provided at a light incident side of the liquid crystal panel, and a second polarizer provided at a light exiting side of the liquid crystal panel.

In the projector, of a light output from the liquid crystal panel, a light as a polarization component reflected or absorbed by the second polarizer is not used as an image light, and there is a problem in efficient use of the light of the light source.

### SUMMARY

In order to solve the above described problem, according to an aspect of the present disclosure, a projector including a light source outputting a light, one liquid crystal panel modulating the light output from the light source based on an image signal, a polarizer reflecting a first light as a first polarization component generating an image light of the light output from the liquid crystal panel, and transmitting a second light as a second polarization component different from the first polarization component of the light output from the liquid crystal panel, and a first solar cell entered by the second light as the second polarization component transmitted through the polarizer, wherein the first solar cell generates electricity from the second light as the second polarization component entering from the polarizer is provided.

According to another aspect of the present disclosure, a projector including a light source outputting a light, one liquid crystal panel modulating the light output from the light source based on an image signal, a polarizer transmitting a first light as a first polarization component generating an image light of the light output from the liquid crystal panel, and reflecting a second light as a second polarization component different from the first polarization component of the light output from the liquid crystal panel, and a first solar cell entered by the second light as the second polarization component reflected by the polarizer, wherein the first solar cell generates electricity from the second light as the second polarization component entering from the polarizer is provided.

### BRIEF DESCRIPTION OF THE DRAWINGS

FIG. 1 is a schematic configuration diagram of a projector of a first embodiment.

FIG. 2 is a sectional view showing a configuration of a main part of a liquid crystal panel.

FIG. 3 shows a configuration of a main part of a projector of a second embodiment.

FIG. 4 shows a configuration of a main part of a projector of a third embodiment.

FIG. 5 shows a configuration of a main part of a projector of a fourth embodiment.

FIG. 6 shows a configuration of a main part of a projector of a fifth embodiment.

FIG. 7 shows a configuration of a main part of a projector of a sixth embodiment.

FIG. 8 shows a configuration of a main part of a projector of a seventh embodiment.

FIG. 9 shows a configuration of a main part of a projector of an eighth embodiment.

FIG. 10 shows a configuration of a main part of a projector of a ninth embodiment.

FIG. 11 shows a configuration of a main part of a projector of a tenth embodiment.

### DESCRIPTION OF EMBODIMENTS

As below, one embodiment of the present disclosure will be explained in detail with reference to the drawings. Note that, in the drawings used in the following explanation, characteristic parts may be enlarged for convenience for clearly showing the characteristics and dimension ratios etc. of the respective component elements are not necessarily the same as real dimension ratios etc.

### First Embodiment

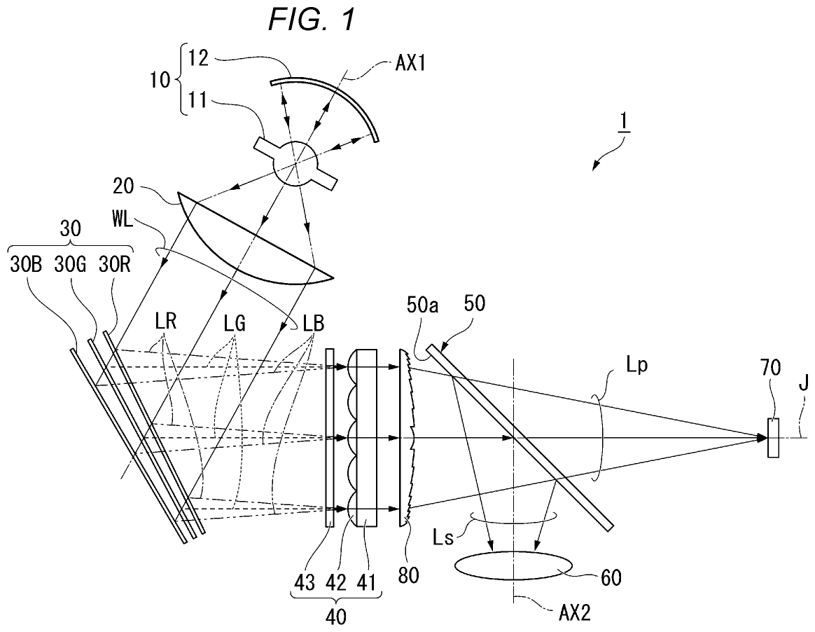

FIG. 1 is a schematic configuration diagram of a projector of the embodiment.

As shown in FIG. 1, a projector 1 of the embodiment includes a light source 10, a collimator lens 20, a color separation unit 30, a light modulation device 40, a polarizer 50, a projection optical device 60, a first solar cell 70, and a light collection system 80.

In the following description, an axis through which a principal ray of a white light WL output from the light source 10 passes is defined as “first optical axis AX1”, an axis passing through the center of the light modulation device 40 as a reference for placement of component members of the the projector 1 is defined as “reference axis J”, and an axis through which a principal ray of an image light passes is defined as “second optical axis AX2”. In the projector 1 of the embodiment, the first optical axis AX1 and the reference axis J form an angle of about 45° and the reference axis J and the second optical axis AX2 are orthogonal to each other.

The light source 10, the collimator lens 20, and the color separation unit 30 are arranged along the first optical axis AX1. The color separation unit 30, the light modulation device 40, the light collection system 80, the polarizer 50, and the first solar cell 70 are arranged along the reference axis J. The polarizer 50 and the projection optical device 60 are arranged along the second optical axis AX2.

The light source 10 has a light emitting unit 11 and a light source reflector 12 provided at a back side of the light emitting unit 11. The light source 10 outputs the white light WL. In the embodiment, the light emitting unit 11 includes e.g., a metal halide lamp, a halogen lamp, or a xenon lamp. Note that the center of the light source reflector 12 is placed to coincide with the center of the light emitting unit 11. In the embodiment, a lamp is used as the light source, however, the light source is not limited to that. A light source using an LED, a laser diode, or a phosphor may be used or outdoor sunlight may be taken in and used as a light source. When sunlight is used, a structure unit outputting sunlight to a liquid crystal panel may be used as a light source. The structure unit includes e.g., a mirror reflecting sunlight, a lens collecting and outputting sunlight, or the like, and an opening of an exterior housing or the like.

The collimator lens 20 parallelizes the white light WL output from the light source 10. The white light WL parallelized by the collimator lens 20 enters the color separation unit 30.

The color separation unit 30 has a red dichroic mirror 30R, a green dichroic mirror 30G, and a blue dichroic mirror 30B, and separates the white light WL output from the light source 10 into a red light LR, a green light LG, and a blue light LB.

The respective dichroic mirrors 30R, 30G, 30B have properties selectively reflecting lights in wavelength ranges of red, green, blue and transmitting lights in the other wavelength ranges, respectively. The respective dichroic mirrors 30R, 30G, 30B are sequentially arranged on an optical axis of the light source 10. The respective dichroic mirrors 30R, 30G, 30B include dielectric multilayer films.

For the red dichroic mirror 30R, a condition of a dielectric multilayer thin film is set to reflect a light in a red wavelength range and transmit lights in a green wavelength range and a blue wavelength range. According to the configuration, the red dichroic mirror 30R reflects and separates the red light LR contained in the white light WL from the lights in the other wavelength ranges.

For the green dichroic mirror 30G, a condition of a dielectric multilayer thin film is set to reflect the light in the green wavelength range and transmit the light in the blue wavelength range. Here, the green dichroic mirror 30G is placed downstream of the red dichroic mirror 30R and the red light LR does not enter. Accordingly, for the green dichroic mirror 30G, the condition of the dielectric multilayer thin film may be set to transmit or reflect the light in the red wavelength range.

According to the configuration, the green dichroic mirror 30G reflects and separates the green light LG contained in the light transmitted through the red dichroic mirror 30R from the light in the blue wavelength range.

Note that the green light LG separated by the green dichroic mirror 30G enters the red dichroic mirror 30R. The red dichroic mirror 30R has the property of transmitting the light in the green wavelength range as described above, and the green light LG separated by the green dichroic mirror 30G is transmitted through the red dichroic mirror 30R.

The blue dichroic mirror 30B is placed downstream of the green dichroic mirror 30G and a condition of the dielectric multilayer thin film is set to reflect the light in the blue wavelength range. That is, for the blue dichroic mirror 30B, the condition of the dielectric multilayer thin film may be set to transmit or reflect the light in the red wavelength range or the green wavelength range.

According to the configuration, the blue dichroic mirror 30B separates the blue light LB transmitted through the green dichroic mirror 30G.

The blue light LB separated by the blue dichroic mirror 30B enters the green dichroic mirror 30G. The green dichroic mirror 30G has the property of transmitting the light in the blue wavelength range as described above, and the blue light LB reflected by the blue dichroic mirror 30B is transmitted through the green dichroic mirror 30G. The blue light LB transmitted through the green dichroic mirror 30G enters the red dichroic mirror 30R. The red dichroic mirror 30R has the property of transmitting the light in the blue wavelength range as described above, and the blue light LB is transmitted through the red dichroic mirror 30R.

Note that the blue dichroic mirror 30B reflects only the blue light LB and may be formed using a mirror.

The respective dichroic mirrors 30R, 30G, 30B are placed so that incident angles of lights to the respective mirrors may be around 45° on the first optical axis AX1 of the light source 10. The green dichroic mirror 30G is placed so that the incident angle of the light may be 45° on the first optical axis AX1. The red dichroic mirror 30R is placed in a position rotated clockwise around a rotation axis orthogonal to the first optical axis AX1 with respect to the green dichroic mirror 30G. The blue dichroic mirror 30B is placed in a position rotated counter-clockwise around the rotation axis orthogonal to the first optical axis AX1 with respect to the green dichroic mirror 30G. Note that the angles relative to one another in the respective dichroic mirrors 30R, 30G, 30B are calculated based on an arrangement pitch of pixels of the light modulation device 40, which will be described later, a focal length of a micro-lens array, etc.

The projector 1 of the embodiment may separate the white light WL into the red light LR, the green light LG, and the blue light LB by the color separation unit 30 and enter the respective color lights into a multi-lens array 42 provided in a liquid crystal panel 41 of the light modulation device 40, which will be described later, at different angles. According to the configuration, the projector 1 of the embodiment may separate the white light WL from the light source 10 into three color lights and enter the respective color lights to the multi-lens array 42 from three directions.

The light modulation device 40 has one liquid crystal panel 41, the multi-lens array 42 provided on a light incident surface of the liquid crystal panel 41, and an incident polarizer 43 provided at a light incident side of the liquid crystal panel 41. The incident polarizer 43 transmits and enters a linearly-polarized light in a predetermined direction of the white light WL into the liquid crystal panel 41 side.

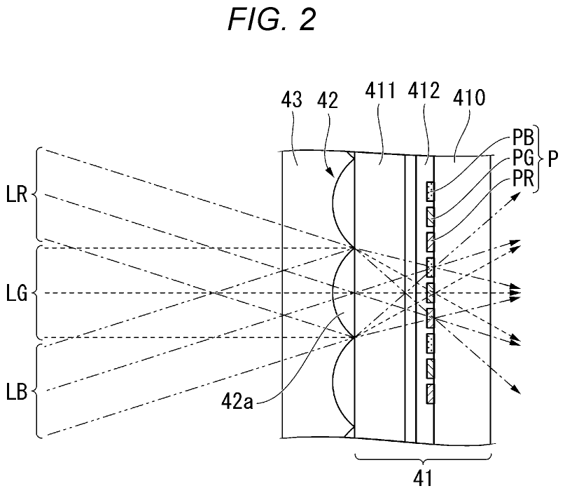

FIG. 2 is a sectional view showing a configuration of a main part of the liquid crystal panel 41.

As shown in FIG. 2, the liquid crystal panel 41 includes an element substrate 410, a counter substrate 411, a liquid crystal layer 412, and the multi-lens array 42. The liquid crystal panel 41 contains a plurality of pixels P. The plurality of pixels P are arranged in a matrix form in horizontal directions of a display screen, i.e., Y directions as lateral directions and vertical directions of the display screen, i.e., Z directions as longitudinal directions.

The respective pixels P include first sub-pixels PR, second sub-pixels PG, and third sub-pixels PB. The respective sub-pixels PR, PG, PB have longitudinally striped shapes extending in the Z directions. The respective sub-pixels PR, PG, PB are areas sectioned by a black matrix BM as a light-shielding member. The liquid crystal panel 41 generates an image light with desired brightness by adjusting applied voltages to the liquid crystal layers 412 placed in the respective sub-pixels PR, PG, PB based on an image signal.

The multi-lens array 42 is provided at a light incident side of the counter substrate 411.

The multi-lens array 42 includes a plurality of lenses 42a provided to correspond to the lateral widths of the respective pixels P. In the embodiment, the respective lenses 42a include e.g., lenticular lenses. Note that the multi-lens array 42 may be integrated with the counter substrate 411.

In the embodiment, the respective lenses 42a of the multi-lens array 42 collect and enter the red light LR entering from the color separation unit 30 into the first sub-pixels PR, collect and enter the green light LG entering from the color separation unit 30 into the second sub-pixels PG, and collect and enter the blue light LB entering from the color separation unit 30 into the third sub-pixels PB.

Returning to FIG. 1, the light collection system 80 is placed between the liquid crystal panel 41 and the polarizer 50. In the embodiment, the light collection system 80 corresponds to “second collection system”.

The light collection system 80 collects the light output from the liquid crystal panel 41. In the embodiment, the light collection system 80 includes a Fresnel lens and functions as a convex lens having positive power. Accordingly, the thickness of the light collection system 80 in directions along the reference axis J is suppressed, and the dimension in the directions along the reference axis J of the projector 1 can be reduced.

Note that, for example, when the restrictions on the downsizing of the projector 1 are unnecessary, the light collection system 80 may be formed using one or more lenses, not the Fresnel lens.

The polarizer 50 includes a reflective polarizer placed at the light exiting side of the liquid crystal panel 41. The polarizer 50 is placed to form an angle of 45° with respect to the reference axis J and the second optical axis AX2.

The polarizer 50 reflects a first light Ls as a first polarization component generating the image light of the modulated light output from the liquid crystal panel 41 and bends the optical path to 90°. The polarizer 50 transmits a second light Lp as a second polarization component different from the first polarization component of the modulated light output from the liquid crystal panel 41.

Generally, a polarizer has a property of efficiently transmitting a light entering as a P-polarized light and efficiently reflecting a light entering as an S-polarized light.

In the embodiment, the first light Ls as the first polarization component is an S-polarized light for a light incident surface 50a of the polarizer 50, and the second light Lp as the second polarization component is a P-polarized light for the light incident surface 50a of the polarizer 50. Accordingly, the polarizer 50 can efficiently reflect the first light Ls as the first polarization component entering as the S-polarized light and efficiently transmit the second light Lp as the second polarization component entering as the P-polarized light.

As described above, in the projector 1 of the embodiment, the first light Ls as one polarization component formed by polarization separation of the modulated light output from the liquid crystal panel 41 by the polarizer 50 can be used for generation of the image light and the second light Lp as the other polarization component formed by polarization separation can be used for power generation of a solar cell as will be described later. Thereby, the projector 1 of the embodiment can use the white light WL output from the light source 10 without waste.

The second light Lp as the second polarization component transmitted through the polarizer 50 enters the first solar cell 70. The first solar cell 70 includes a photoelectric conversion power generation element that can convert optical energy into electrical energy. Accordingly, the first solar cell 70 generates electricity from the second light Lp as the second polarization component entering from the polarizer 50.

The projector 1 of the embodiment realizes lower power consumption using the electricity generated by the first solar cell 70 as drive power for the projector.

In the projector 1 of the embodiment, the second light Lp as the second polarization component passes through the light collection system 80, is collected, and enters the first solar cell 70. In the embodiment, a photoelectric conversion element surface of the first solar cell 70 is placed near the focal point of the light collection system 80. According to the configuration, irradiation light density of the second light Lp on the photoelectric conversion element surface of the first solar cell 70 increases and the generated voltage of the first solar cell 70 rises, and extraction efficiency of the power can be increased. Further, the first solar cell 70 having the smaller size can be employed, and thereby, the lower cost and downsizing of the apparatus configuration can be realized.

Note that, in the optical path of the second light Lp between the polarizer 50 and the first solar cell 70, a mirror and a lens are appropriately added according to the product size required for the projector 1, and thereby, the optical path may be bended, shortened, or extended.

The projection optical device 60 displays a predetermined image by projecting the first light Ls reflected by the polarizer 50 on a projected surface such as a screen. The projection optical device 60 has one or more projection lenses.

As described above, the projector 1 of the embodiment includes the light source 10 outputting the white light WL, one liquid crystal panel 41 modulating the white light WL output from the light source 10 based on the image signal, the polarizer 50 reflecting the first light Ls as the first polarization component generating the image light of the light output from the liquid crystal panel 41 and transmitting the second light Lp as the second polarization component of the light output from the liquid crystal panel 41, and the first solar cell 70 entered by the second light Lp as the second polarization component transmitted through the polarizer 50, and the first solar cell 70 generates electricity from the second light Lp as the second polarization component entering from the polarizer 50.

According to the projector 1 of the embodiment, the second light Lp transmitted through the polarizer 50 and not used for the generation of the image light of the light modulated in the liquid crystal panel 41 is entered into the first solar cell 70, and thereby, can be used for generation of electricity. Therefore, according to the projector 1 of the embodiment, the white light WL output from the light source 10 can be efficiently used.

### Second Embodiment

Subsequently, a configuration of a projector of a second embodiment will be explained.

The basic configuration of the projector of the second embodiment is the same as that of the first embodiment, but the second embodiment is different from the first embodiment in that a collector lens is used in place of the light collection system 80. As below, the explanation of the common parts with the first embodiment will be omitted and the common members and configurations with the first embodiment will be explained with the same signs.

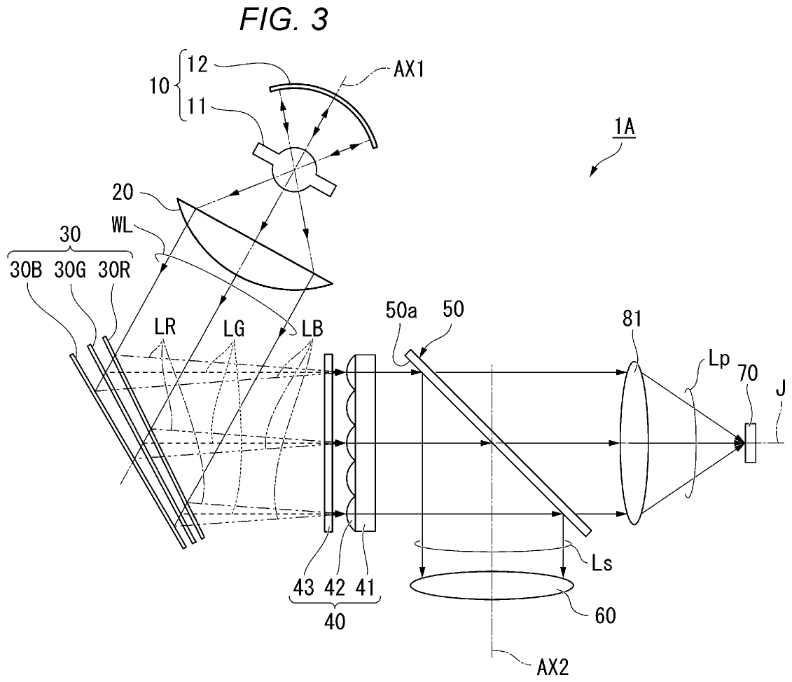

FIG. 3 shows a configuration of a main part of the projector of the embodiment.

As shown in FIG. 3, a projector 1A of the embodiment includes the light source 10, the collimator lens 20, the color separation unit 30, the light modulation device 40, the polarizer 50, the projection optical device 60, the first solar cell 70, and a collector lens 81.

In the projector 1A of the embodiment, the color separation unit 30, the light modulation device 40, the polarizer 50, the collector lens 81, and the first solar cell 70 are arranged along the reference axis J.

In the projector 1A of the embodiment, the collector lens 81 is provided in place of the light collection system 80 of the projector 1 of the embodiment. The collector lens 81 is placed between the polarizer 50 and the first solar cell 70. Note that the collector lens 81 may include one or more lenses. In the embodiment, the collector lens 81 corresponds to “first collection system”.

In the projector 1A of the embodiment, the second light Lp as the second polarization component transmitted through the polarizer 50 is collected by the collector lens 81 and enters the first solar cell 70. In the embodiment, the photoelectric conversion element surface of the first solar cell 70 is placed near the focal point of the collector lens 81 and the irradiation light density of the second light Lp on the photoelectric conversion element surface of the first solar cell 70 may be increased, and the generated voltage of the first solar cell 70 is raised and extraction efficiency of the power can be increased. Further, the first solar cell 70 having the smaller size may be employed, and thereby, the lower cost and downsizing of the apparatus configuration can be realized.

### Third Embodiment

Subsequently, a configuration of a projector of a third embodiment will be explained.

The basic configuration of the projector of the third embodiment is the same as that of the second embodiment, but the third embodiment is different from the second embodiment in that an aperture is provided upstream of the first solar cell 70. As below, the explanation of the common parts with the second embodiment will be omitted and the common members and configurations with the second embodiment will be explained with the same signs.

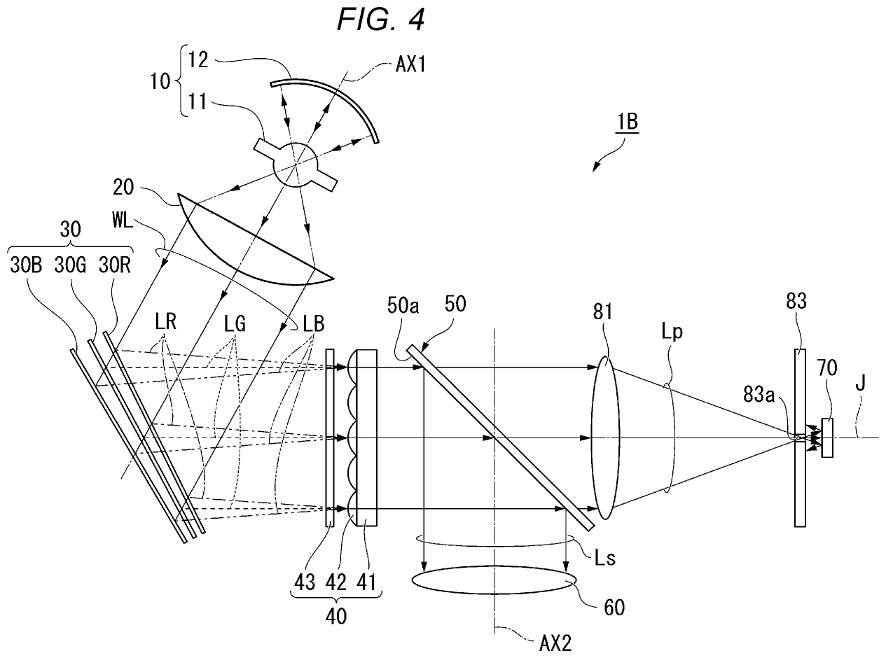

FIG. 4 shows a configuration of a main part of the projector of the embodiment.

As shown in FIG. 4, a projector 1B of the embodiment includes the light source 10, the collimator lens 20, the color separation unit 30, the light modulation device 40, the polarizer 50, the projection optical device 60, the first solar cell 70, the collector lens 81, and an aperture 83.

In the embodiment, the color separation unit 30, the light modulation device 40, the polarizer 50, the collector lens 81, the aperture 83, and the first solar cell 70 are arranged along the reference axis J.

The aperture 83 is placed between the collector lens 81 and the first solar cell 70. The aperture 83 has an opening 83a through which the second light Lp collected by the collector lens 81 passes. The aperture 83 includes a plate-like member having a light shielding property or a light absorption property and blocks the light reflected by a light incident surface 70a forming the photoelectric conversion element surface of the first solar cell 70. Note that the planar area of the aperture 83 is larger than the planar area of the light incident surface 70a of the first solar cell 70.

It is desirable that the opening 83a of the aperture 83 is placed near the focal point of the collector lens 81. According to the configuration, the second light Lp collected to have a suppressed luminous flux width passes, and a leakage of a reflected component of the second light Lp from the opening 83a can be suppressed by minimization of the opening width of the opening 83a.

If the aperture 83 is not provided, the reflected light of the second light Lp by the light incident surface 70a of the first solar cell 70 is output at a larger radiation angle. Accordingly, the reflected light of the second light Lp may become stray light and reduce the contrast of the image light, and the image quality may be lower.

According to the projector 1B of the embodiment, the aperture 83 placed between the collector lens 81 and the first solar cell 70 is provided, and the reflected light of the second light Lp by the light incident surface 70a of the first solar cell 70 can be blocked. Thereby, the defect that the reflected light of the second light Lp becomes stray light, reduces the contrast of the image light, and lowers the image quality can be suppressed.

Note that the aperture 83 is provided in the projector 1 of the first embodiment, and thereby, the defect by the reflected light of the second light Lp may be suppressed.

### Fourth Embodiment

Subsequently, a configuration of a projector of a fourth embodiment will be explained.

The basic configuration of the projector of the fourth embodiment is the same as that of the second embodiment, but the fourth embodiment is different from the second embodiment in that the first solar cell 70 is placed with an inclination. As below, the explanation of the common parts with the second embodiment will be omitted and the common members and configurations with the second embodiment will be explained with the same signs.

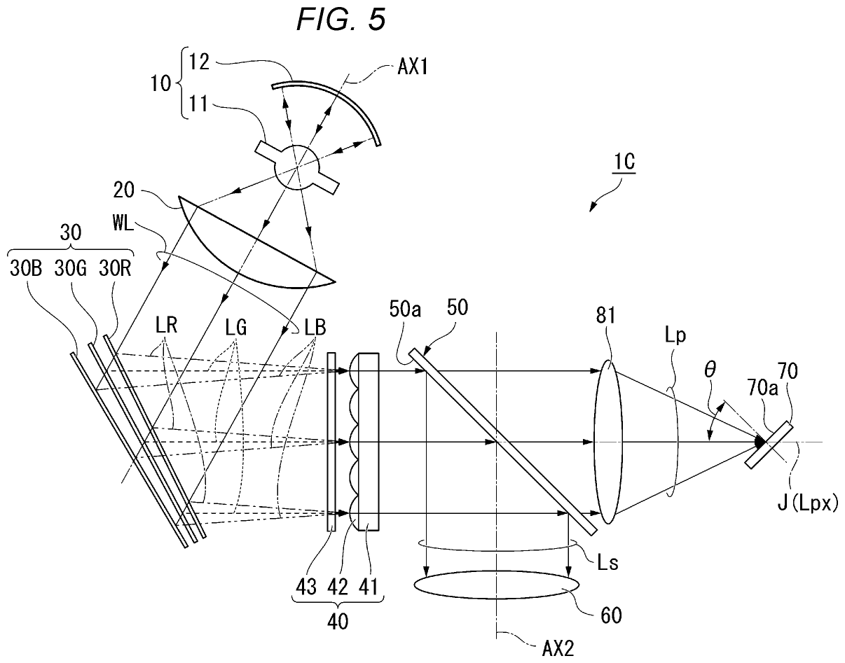

FIG. 5 shows a configuration of a main part of the projector of the embodiment.

As shown in FIG. 5, in a projector 1C of the embodiment, the light incident surface 70a of the first solar cell 70 is inclined at a predetermined angle with respect to the reference axis J.

The second light Lp transmitted through the polarizer 50 is a linearly-polarized light substantially aligned in polarization. In the embodiment, the first solar cell 70 is placed so that the second light Lp enters as a P-polarized light for the light incident surface 70a. That is, the second light Lp is the P-polarized light for the light incident surface 70a of the first solar cell 70.

In the embodiment, the first solar cell 70 is placed so that an angle θ formed by an optical axis Lpx of the second light Lp entering as the P-polarized light and the light incident surface 70a is a Brewster angle.

As described above, according to the projector 1C of the embodiment, the second light Lp enters the light incident surface 70a of the first solar cell 70 as the P-polarized light at the Brewster angle, and a larger part of the second light Lp is not reflected by the light incident surface 70a of the first solar cell 70, but taken therein. Therefore, in the projector 1C of the embodiment, the first solar cell 70 efficiently takes in the second light Lp and energy regeneration efficiency can be further improved.

Note that the first solar cell 70 is placed with an inclination in the projector 1 of the first embodiment, and thereby, the second light Lp may be entered into the light incident surface 70a as the P-polarized light at the Brewster angle and the defect by the reflected light of the second light Lp may be suppressed.

### Fifth Embodiment

Subsequently, a configuration of a projector of a fifth embodiment will be explained.

The basic configuration of the projector of the fifth embodiment is the same as that of the fourth embodiment, but the fifth embodiment is different from the fourth embodiment in that a lens is placed at the light incident side of the first solar cell 70. As below, the explanation of the common parts with the fourth embodiment will be omitted and the common members and configurations with the fourth embodiment will be explained with the same signs.

In the projector 1C of the fourth embodiment, the second light Lp enters the first solar cell 70 with a predetermined spread. Accordingly, a part of the second light Lp enters the light incident surface 70a of the first solar cell 70 at an angle different from the Brewster angle. On the other hand, in the projector of the embodiment, the second light Lp is converted into parallel luminous flux, and thereby, the second light Lp is efficiently taken into the light incident surface 70a of the first solar cell 70. As below, a configuration of the projector of the embodiment will be explained.

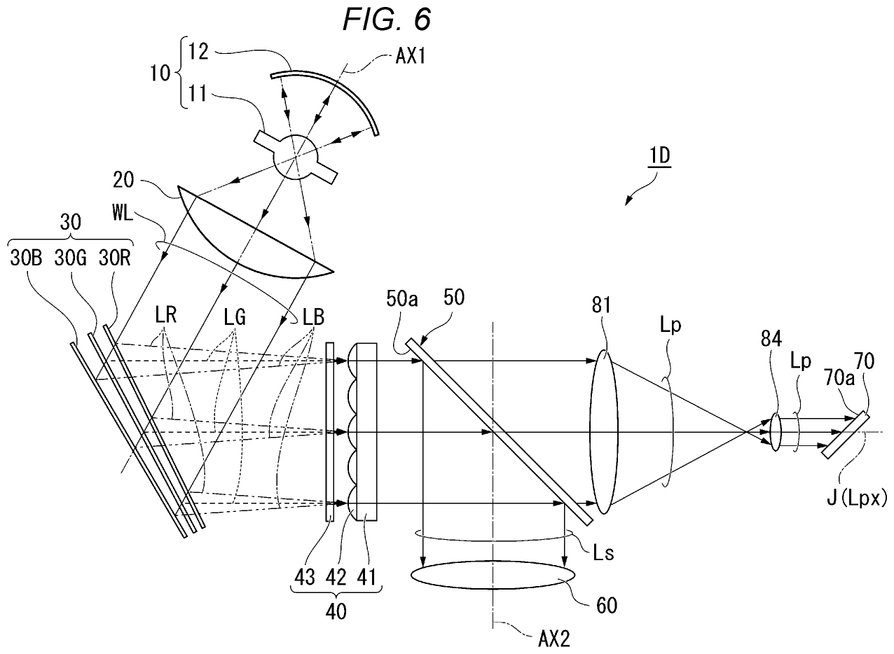

FIG. 6 shows a configuration of a main part of the projector of the embodiment.

As shown in FIG. 6, in a projector 1D of the embodiment, a collimator lens 84 placed at the light incident side of the first solar cell 70 is provided, and the second light Lp is parallelized by the collimator lens 84 and entered into the light incident surface 70a of the first solar cell 70. Note that the collimator lens 84 placed upstream of the collection position of the second light Lp includes a concave lens, and the collimator lens 84 placed downstream of the collection position of the second light Lp includes a convex lens.

According to the configuration, the second light Lp is converted into parallel luminous flux and most of the second light Lp enters the light incident surface 70a of the first solar cell 70 at the Brewster angle. Therefore, the second light Lp is not reflected by the light incident surface 70a of the first solar cell 70, but taken therein, and the energy regeneration efficiency can be further increased compared to that in the configuration of the fourth embodiment.

### Sixth Embodiment

Subsequently, a configuration of a projector of a sixth embodiment will be explained.

The basic configuration of the projector of the sixth embodiment is the same as that of the fifth embodiment, but the sixth embodiment is different from the fifth embodiment in that the second light Lp is separated and entered into two solar cells. As below, the explanation of the common parts with the fifth embodiment will be omitted and the common members and configurations with the fifth embodiment will be explained with the same signs.

The inventor of the present disclosure was focused on significant reduction of photoelectric conversion efficiency of a solar cell formed using an inappropriate material for the wavelength range of the entering light because an appropriate material forming a solar cell differs with respect to each wavelength range of the light entering the solar cell depending on a relationship between the photoelectric conversion efficiency of the solar cell and the wavelength range of the incident light. Accordingly, the inventor found the configuration of the embodiment increasing the photoelectric conversion efficiency by spectroscopically separating the incident light before entry into the solar cell and entering the spectroscopically separated lights in the respective wavelength ranges into the plurality of solar cells formed using different materials.

As below, a configuration of the projector of the embodiment will be specifically explained.

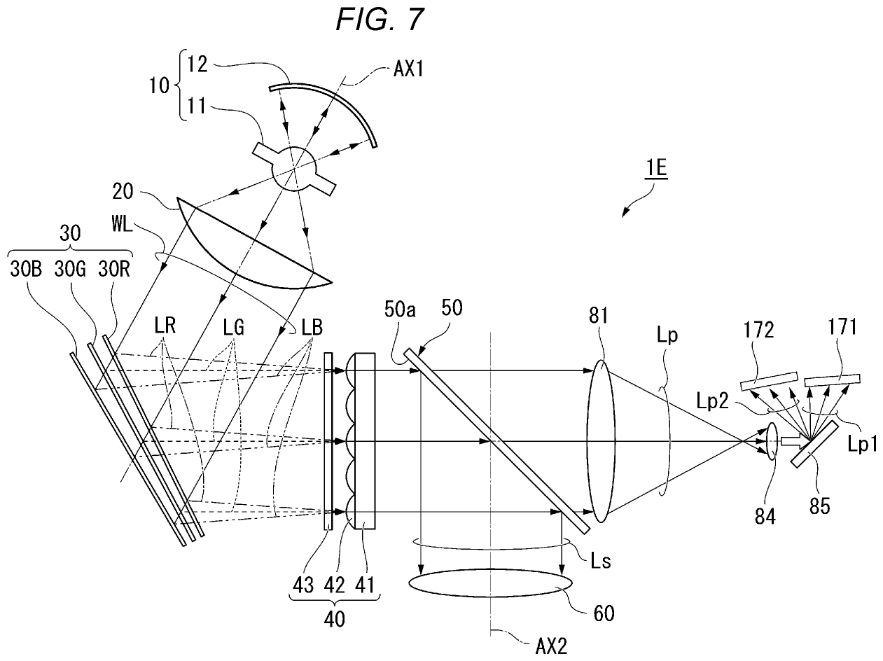

FIG. 7 shows a configuration of a main part of the projector of the embodiment.

As shown in FIG. 7, a projector 1E of the embodiment includes the light source 10, the collimator lens 20, the color separation unit 30, the light modulation device 40, the polarizer 50, the projection optical device 60, a first solar cell 171, a second solar cell 172, the collector lens 81, the collimator lens 84, and a reflector 85.

The second light Lp transmitted through the polarizer 50 is parallelized by the collimator lens 84 and enters the reflector 85. The reflector 85 of the embodiment includes a reflective diffraction element. The reflector 85 spectroscopically separates the second light Lp into two components. In the case of the embodiment, the reflector 85 reflects a first separated light Lp1 as a light in a longer wavelength range (a light in a first wavelength range) of the second light Lp toward the first solar cell 171, and reflects a second separated light Lp2 as a light in a shorter wavelength range different from (having shorter wavelengths than) the longer wavelength range (a light in a second wavelength range) of the second light Lp toward the second solar cell 172.

In the embodiment, first photoelectric conversion efficiency for the first separated light Lp1 of the first solar cell 171 is higher than second photoelectric conversion efficiency for the second separated light Lp2 of the first solar cell 171.

That is, the first solar cell 171 is formed using a material suitable for the wavelength range of the first separated light Lp1. As the material for the first solar cell 171 suitable for the longer wavelength range, e.g., InGaAs is used.

In the embodiment, third photoelectric conversion efficiency for the second separated light Lp2 of the second solar cell 172 is higher than fourth photoelectric conversion efficiency for the first separated light Lp1 of the second solar cell 172.

That is, the second solar cell 172 is formed using a material suitable for the wavelength range of the second separated light Lp2. As the material for the second solar cell 172 suitable for the light in the shorter wavelength range, a compound e.g., InGaP is desirably used in terms of photoelectric conversion efficiency, however, Si may be used.

In consideration of the wavelength distribution of the light output by the projector 1E of the embodiment, the distribution is limited to a significantly narrow range compared to sunlight, and the photoelectric conversion efficiency can be increased more using the compound material than Si. Note that, if a single material, not a junction-type compound material, may be used, the decrease in efficiency at junction is eliminated and the degree of freedom is increased for the selection of the thickness necessary as the material, and thereby, the property may be varied for increase in photoelectric conversion efficiency.

According to the projector 1E of the embodiment, the first separated light Lp1 and the second separated light Lp2 formed by spectroscopic separation of the second light Lp may be entered into the first solar cell 171 and the second solar cell 172 respectively formed using the suitable materials. Accordingly, the photoelectric conversion efficiency of the first solar cell 171 and the second solar cell 172 is increased, and thereby, the energy regeneration efficiency in the projector can be further increased compared to the configuration of the fifth embodiment.

Note that, in the projector 1E of the embodiment, the reflective diffraction grating is used as the reflector 85 that spectroscopically separates the second light Lp, however, the second light Lp may be spectroscopically separated by a dichroic mirror or the like.

Further, the configuration of the embodiment is combined with the projector 1 of the first embodiment, and thereby, the photoelectric conversion efficiency of the solar cell may be increased and the extraction efficiency of power may be increased.

### Seventh Embodiment

Subsequently, a configuration of a projector of a seventh embodiment will be explained.

The basic configuration of the projector of the seventh embodiment is the same as that of the first embodiment, but the seventh embodiment is different from the first embodiment in the position relationship between the first solar cell and the projection optical device with respect to the polarizer. As below, the explanation of the common parts with the first embodiment will be omitted and the common members and configurations with the first embodiment will be explained with the same signs.

In a projector 1F of the embodiment, the axis through which the principal ray of the white light WL output from the light source 10 passes is defined as “first optical axis AX1”, an axis passing through the center of the light modulation device 40 as a reference for placement of part of the component members of the projector 1F is defined as “first reference axis J1”, the axis through which the principal ray of the image light passes is defined as “second optical axis AX2”, and an axis orthogonal to the first reference axis J1 as a reference for placement of another part of the component members of the projector 1F is defined as “second reference axis J2”. In the projector 1F of the embodiment, the first optical axis AX1 and the first reference axis J1 form an angle of about 45° and the first reference axis J1 and the second optical axis AX2 are aligned with each other.

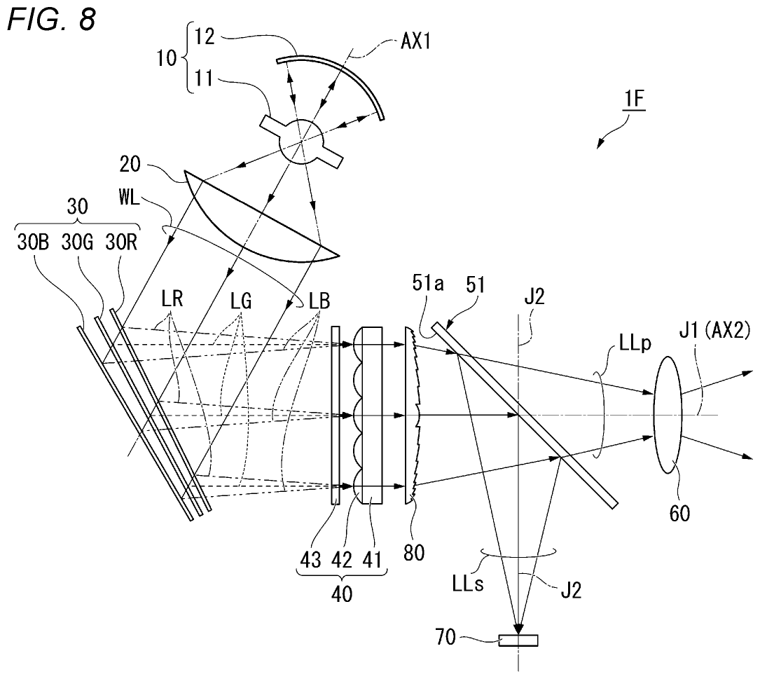

FIG. 8 shows a configuration of a main part of the projector of the embodiment.

As shown in FIG. 8, in the projector 1F of the embodiment, the color separation unit 30, the light modulation device 40, the light collection system 80, a polarizer 51, and the projection optical device 60 are arranged along the first reference axis J1 and the second optical axis AX2. The polarizer 51 and the first solar cell 70 are arranged along the second reference axis J2.

The polarizer 51 is placed to form an angle of 45° with respect to the first reference axis J1.

The polarizer 51 transmits a first light LLp as a first polarization component generating the image light of the light output from the liquid crystal panel 41. The polarizer 51 reflects a second light LLs as a second polarization component different from the first polarization component of the light output from the liquid crystal panel 41.

In the embodiment, the first light LLp as the first polarization component is a P-polarized light for a light incident surface 51a of the polarizer 51, and the second light LLs as the second polarization component is an S-polarized light for the light incident surface 51a of the polarizer 51. Accordingly, the polarizer 51 can efficiently transmit the first light LLp as the first polarization component entering as the P-polarized light and efficiently reflect the second light LLs as the second polarization component entering as the S-polarized light.

In the embodiment, the second light LLs as the second polarization component reflected by the polarizer 51 enters the first solar cell 70. The first solar cell 70 generates electricity from the second light LLs as the second polarization component entering from the polarizer 51.

As described above, in the projector 1F of the embodiment, the first light LLp as one polarization component formed by polarization separation of the modulated light output from the liquid crystal panel 41 is used for generation of the image light and the second light LLs as the other polarization component formed by polarization separation of the modulated light is used for power generation of the first solar cell 70. Thereby, the projector 1F of the embodiment can use the white light WL output from the light source 10 without waste.

As described above, the projector 1F of the embodiment includes the light source 10 outputting the white light WL, one liquid crystal panel 41 modulating the white light WL output from the light source 10 based on the image signal, the polarizer 51 transmitting the first light LLp as the first polarization component generating the image light of the light output from the liquid crystal panel 41 and reflecting the second light LLs as the second polarization component of the light output from the liquid crystal panel 41, and the first solar cell 70 entered by the second light LLs as the second polarization component reflected by the polarizer 51, and the first solar cell 70 generates electricity from the second light LLs as the second polarization component entering from the polarizer 51.

According to the projector 1F of the embodiment, the second light LLs reflected by the polarizer 51 and not used for the generation of the image light of the light modulated in the liquid crystal panel 41 is entered into the first solar cell 70, and thereby, can be used for generation of electricity. Therefore, according to the projector 1F of the embodiment, the white light WL output from the light source 10 can be efficiently used.

### Eighth Embodiment

Subsequently, a configuration of a projector of an eighth embodiment will be explained.

The basic configuration of the projector of the eighth embodiment is the same as that of the seventh embodiment, but the eighth embodiment is different from the seventh embodiment in that a collector lens is used in place of the light collection system 80. As below, the explanation of the common parts with the seventh embodiment will be omitted and the common members and configurations with the seventh embodiment will be explained with the same signs.

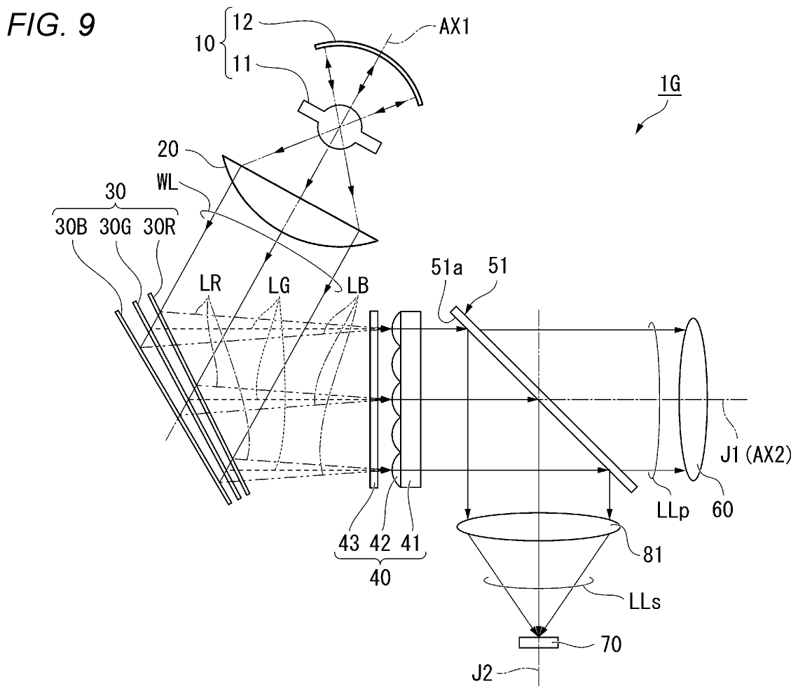

FIG. 9 shows a configuration of a main part of the projector of the embodiment.

As shown in FIG. 9, a projector 1G of the embodiment includes the light source 10, the collimator lens 20, the color separation unit 30, the light modulation device 40, the polarizer 51, the projection optical device 60, the first solar cell 70, and the collector lens 81.

In the projector 1G of the embodiment, the polarizer 51, the collector lens 81, and the first solar cell 70 are arranged along the second reference axis J2. That is, the collector lens 81 is placed between the polarizer 51 and the first solar cell 70.

In the projector 1G of the embodiment, the second light LLs as the second polarization component reflected by the polarizer 51 is collected by the collector lens 81 and enters the first solar cell 70. In the embodiment, the photoelectric conversion element surface of the first solar cell 70 is placed near the focal point of the collector lens 81 and the irradiation light density of the second light LLs on the photoelectric conversion element surface of the first solar cell 70 may be increased, and the generated voltage of the first solar cell 70 is raised and the extraction efficiency of the power can be increased. Further, the first solar cell 70 having the smaller size can be employed, and thereby, the lower cost and downsizing of the apparatus configuration can be realized.

### Ninth Embodiment

Subsequently, a configuration of a projector of a ninth embodiment will be explained.

The basic configuration of the projector of the ninth embodiment is the same as that of the eighth embodiment, but the ninth embodiment is different from the eighth embodiment in that the first solar cell 70 is placed with an inclination. That is, the projector of the embodiment has a configuration as a combination of the configuration of the seventh embodiment with the configuration of the fourth embodiment. As below, the explanation of the common parts with the eighth embodiment will be omitted and the common members and configurations with the eighth embodiment will be explained with the same signs.

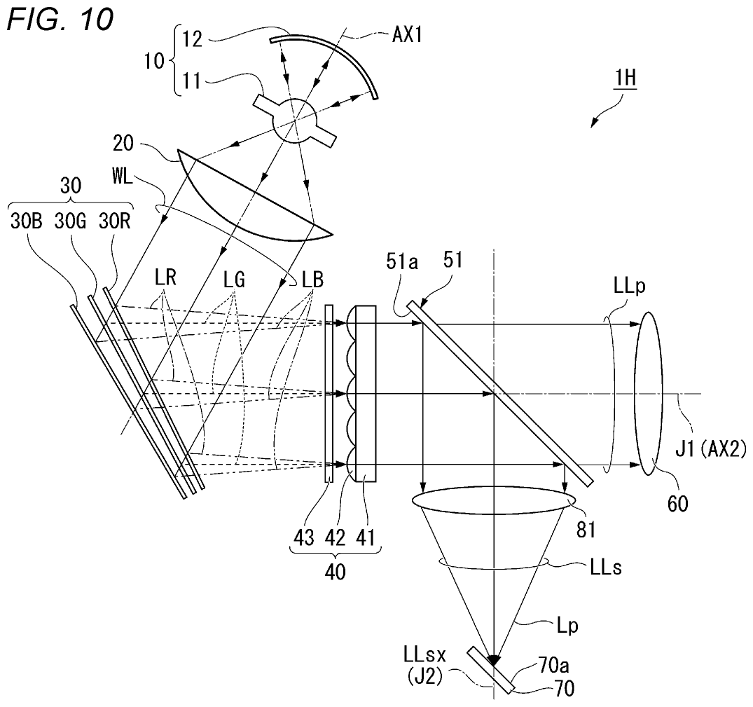

FIG. 10 shows a configuration of a main part of the projector of the embodiment.

As shown in FIG. 10, in a projector 1H of the embodiment, the light incident surface 70a of the first solar cell 70 is inclined at a predetermined angle with respect to the second reference axis J2.

The second light LLs reflected by the polarizer 51 is a linearly-polarized light substantially aligned in polarization. In the embodiment, the first solar cell 70 is placed so that the second light LLs enters as a P-polarized light for the light incident surface 70a. That is, the second light LLs is the P-polarized light for the light incident surface 70a of the first solar cell 70.

In the embodiment, the first solar cell 70 is placed so that an angle formed by an optical axis LLsx of the second light LLs entering as the P-polarized light and the light incident surface 70a is a Brewster angle.

As described above, according to the projector 1H of the embodiment, the second light LLs enters the light incident surface 70a of the first solar cell 70 as the P-polarized light at the Brewster angle, and a larger part of the second light LLs is not reflected by the light incident surface 70a of the first solar cell 70, but taken therein. Therefore, in the projector 1H of the embodiment, the first solar cell 70 efficiently takes in the second light LLs and the energy regeneration efficiency can be further improved.

Note that the first solar cell 70 is placed with an inclination in the projector 1G of the eighth embodiment, and thereby, the second light LLs may be entered into the light incident surface 70a as the P-polarized light at the Brewster angle and the defect by the reflected light of the second light Lp may be suppressed.

### Tenth Embodiment

Subsequently, a configuration of a projector of a tenth embodiment will be explained.

The basic configuration of the projector of the tenth embodiment is the same as that of the ninth embodiment, but the tenth embodiment is different from the ninth embodiment in that the second light LLs is separated and entered into two solar cells. That is, the projector of the embodiment has a configuration as a combination of the configuration of the ninth embodiment with the configuration of the sixth embodiment. As below, the explanation of the common parts with the ninth embodiment will be omitted and the common members and configurations with the ninth embodiment will be explained with the same signs.

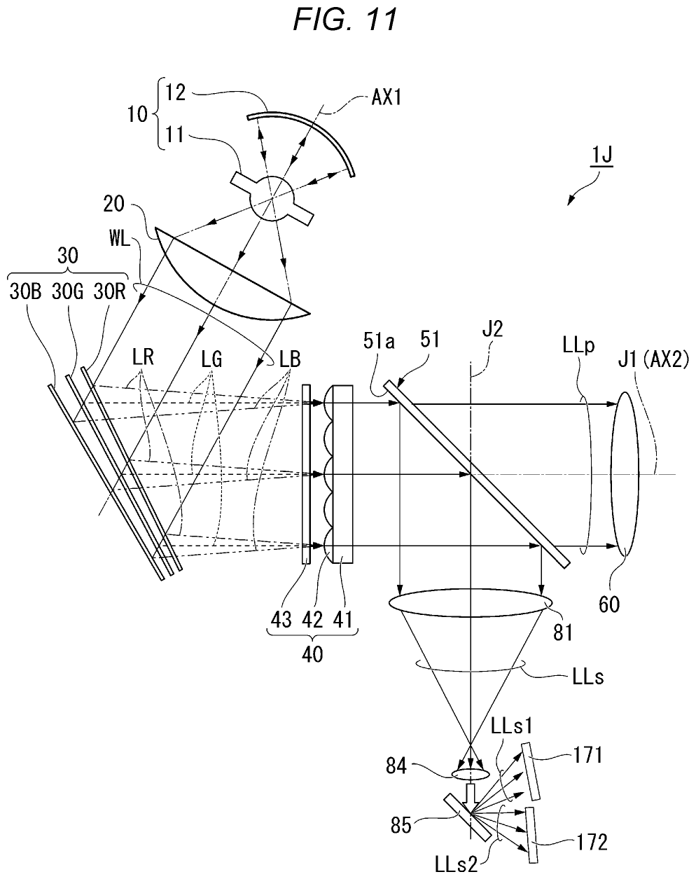

FIG. 11 shows a configuration of a main part of the projector of the embodiment.

As shown in FIG. 11, a projector 1J of the embodiment includes the light source 10, the collimator lens 20, the color separation unit 30, the light modulation device 40, the polarizer 51, the projection optical device 60, the first solar cell 171, the second solar cell 172, the collector lens 81, the collimator lens 84, and the reflector 85.

The second light LLs reflected by the polarizer 51 enters reflector 85. The reflector 85 spectroscopically separates the second light LLs into two components. In the case of the embodiment, the reflector 85 reflects a first separated light LLs1 as a light in a longer wavelength range of the second light LLs reflected by the polarizer 51 toward the first solar cell 171, and reflects a second separated light LLs2 as a light in a shorter wavelength range than the longer wavelength range of the second light LLs reflected by the polarizer 51 toward the second solar cell 172.

In the embodiment, first photoelectric conversion efficiency for the first separated light LLs1 of the first solar cell 171 is higher than second photoelectric conversion efficiency for the second separated light LLs2 of the first solar cell 171. Further, third photoelectric conversion efficiency for the second separated light LLs2 of the second solar cell 172 is higher than fourth photoelectric conversion efficiency for the first separated light LLs1 of the second solar cell 172.

According to the projector 1J of the embodiment, the first separated light LLs1 and the second separated light LLs2 formed by spectroscopic separation of the second light LLs can be entered into the first solar cell 171 and the second solar cell 172 respectively formed using the suitable materials. Accordingly, the photoelectric conversion efficiency of the first solar cell 171 and the second solar cell 172 is increased, and thereby, the energy regeneration efficiency in the projector can be further increased compared to the configuration of the fifth embodiment.

Further, the configuration of the projector 1J of the embodiment is combined with the projector 1F of the seventh embodiment, and thereby, the photoelectric conversion efficiency of the solar cell may be increased and the extraction efficiency of power may be increased.

Note that the technical scope of the present disclosure is not limited to the above described embodiments, but various changes can be made without departing from the scope of the present disclosure.

In addition, the specific configurations including the numbers, the placements, the shapes, the materials, etc. of the respective component elements forming the projectors are not limited to those in the above described embodiments, but changes can be appropriately made.

For example, in the configurations of the seventh embodiment to the tenth embodiment, the aperture 83 used in the third embodiment may be placed between the collector lens 81 and the first solar cell 70 and the reflected light of the second light Lp by the light incident surface 70a of the first solar cell 70 may be blocked. Thereby, image quality degradation due to the reflected light of the second light Lp becoming stray light and the reduced contrast of the image light can be suppressed.

As below, the summary of the present disclosure will be appended.

### Appendix 1

A projector includes a light source outputting a light, one liquid crystal panel modulating the light output from the light source based on an image signal, a polarizer reflecting a first light as a first polarization component generating an image light of the light output from the liquid crystal panel, and transmitting a second light as a second polarization component different from the first polarization component of the light output from the liquid crystal panel, and a first solar cell entered by the second light as the second polarization component transmitted through the polarizer, wherein the first solar cell generates electricity from the second light as the second polarization component entering from the polarizer.

According to the projector having the configuration, the second light transmitted through the polarizer and not used for the generation of the image light of the light modulated in the liquid crystal panel is entered into the first solar cell, and thereby, can be used for generation of electricity. Therefore, according to the projector having the above described configuration, the light output from the light source can be efficiently used.

### Appendix 2

A projector includes a light source outputting light, one liquid crystal panel modulating the light output from the light source based on an image signal, a polarizer transmitting a first light as a first polarization component generating an image light of the light output from the liquid crystal panel, and reflecting a second light as a second polarization component different from the first polarization component of the light output from the liquid crystal panel, and a first solar cell entered by the second light as the second polarization component reflected by the polarizer, wherein the first solar cell generates electricity from the second light as the second polarization component entering from the polarizer.

According to the configuration, the second light reflected by the polarizer and not used for the generation of the image light of the light modulated in the liquid crystal panel is entered into the first solar cell, and thereby, can be used for generation of electricity. Therefore, according to the projector having the above described configuration, the light output from the light source can be efficiently used.

### Appendix 3

In the projector according to Appendix 1, the first light as the first polarization component is an S-polarized light for a light incident surface of the polarizer, and the second light as the second polarization component is a P-polarized light for the light incident surface of the polarizer.

According to the configuration, the light as the first polarization component may be reflected and the light as the second polarization component can be efficiently transmitted in the polarizer, and a loss when the light is separated by the polarizer can be reduced.

### Appendix 4

In the projector according to Appendix 2, the first light as the first polarization component is a P-polarized light for a light incident surface of the polarizer, and the second light as the second polarization component is an S-polarized light for the light incident surface of the polarizer.

According to the configuration, the light as the first polarization component may be transmitted and the light as the second polarization component can be efficiently reflected in the polarizer, and a loss when the light is separated by the polarizer can be reduced.

### Appendix 5

The projector according to Appendix 1 further includes a first collection system placed between the polarizer and the first solar cell and collecting the second light as the second polarization component transmitted through the polarizer on the first solar cell.

According to the configuration, the light as the second polarization component transmitted through the polarizer is collected by the first collection system and enters the first solar cell. Thereby, the generated voltage of the first solar cell may be raised and extraction efficiency of the power can be increased. Further, the first solar cell having the smaller size can be employed, and thereby, the lower cost and downsizing of the apparatus configuration can be realized.

### Appendix 6

The projector according to Appendix 2 further includes a first collection system placed between the polarizer and the first solar cell and collecting the second light as the second polarization component reflected by the polarizer on the first solar cell.

According to the configuration, the light as the second polarization component reflected by the polarizer is collected by the first collection system and enters the first solar cell. Thereby, the generated voltage of the first solar cell may be raised and extraction efficiency of the power can be increased. Further, the first solar cell having the smaller size can be employed, and thereby, the lower cost and downsizing of the apparatus configuration can be realized.

### Appendix 7

In the projector according to Appendix 1, the first solar cell has a light incident surface entered by the second light as the second polarization component transmitted through the polarizer, the second light as the second polarization component is a P-polarized light for the light incident surface of the first solar cell, and the first solar cell is placed so that an angle formed by an optical axis of the second light as the second polarization component and the light incident surface is a Brewster angle.

According to the configuration, the light as the second polarization component transmitted through the polarizer enters the light incident surface of the first solar cell as the P-polarized light at the Brewster angle, and a larger part of the light as the second polarization component is not reflected by the light incident surface of the first solar cell, but taken therein. Therefore, according to the projector having the above described configuration, the first solar cell efficiently takes in the light as the second polarization component and energy regeneration efficiency can be further improved.

### Appendix 8

In the projector according to Appendix 2, the first solar cell has a light incident surface entered by the second light as the second polarization component reflected by the polarizer, the second light as the second polarization component is a P-polarized light for the light incident surface of the first solar cell, and the first solar cell is placed so that an angle formed by an optical axis of the second light as the second polarization component and the light incident surface is a Brewster angle.

According to the configuration, the light as the second polarization component reflected by the polarizer enters the light incident surface of the first solar cell as the P-polarized light at the Brewster angle, and a larger part of the light as the second polarization component is not reflected by the light incident surface of the first solar cell, but taken therein. Therefore, according to the projector having the above described configuration, the first solar cell efficiently takes in the light as the second polarization component and energy regeneration efficiency can be further improved.

### Appendix 9

The projector according to Appendix 1 further includes a reflector entered by the second light as the second polarization component transmitted through the polarizer, and a second solar cell entered by a part of the second light as the second polarization component reflected by the reflector, wherein the reflector reflects a light in a first wavelength range of the second light as the second polarization component transmitted through the polarizer toward the first solar cell, and reflects a light in a second wavelength range different from the first wavelength range of the second light as the second polarization component transmitted through the polarizer toward the second solar cell, first photoelectric conversion efficiency for the light in the first wavelength range of the first solar cell is higher than second photoelectric conversion efficiency for the light in the second wavelength range of the first solar cell, and third photoelectric conversion efficiency for the light in the second wavelength range of the second solar cell is higher than fourth photoelectric conversion efficiency for the light in the first wavelength range of the second solar cell.

According to the configuration, the light in the first wavelength range and the light in the second wavelength range formed by separation by the reflector of the light as the second polarization component reflected by the polarizer can be entered into the first solar cell and the second solar cell respectively formed using suitable materials. Therefore, the photoelectric conversion efficiency of the first solar cell and the second solar cell is increased, and thereby, the energy regeneration efficiency in the projector can be further increased.

### Appendix 10

The projector according to Appendix 1 further includes a reflector entered by the second light as the second polarization component reflected by the polarizer, and a second solar cell entered by a part of the second light as the second polarization component reflected by the reflector, wherein the reflector reflects a light in a first wavelength range of the second light as the second polarization component reflected by the polarizer toward the first solar cell, and reflects a light in a second wavelength range different from the first wavelength range of the second light as the second polarization component reflected by the polarizer toward the second solar cell, first photoelectric conversion efficiency for the light in the first wavelength range of the first solar cell is higher than second photoelectric conversion efficiency for the light in the second wavelength range of the first solar cell, and third photoelectric conversion efficiency for the light in the second wavelength range of the second solar cell is higher than fourth photoelectric conversion efficiency for the light in the first wavelength range of the second solar cell.

According to the configuration, the light in the first wavelength range and the light in the second wavelength range formed by separation by the reflector of the light as the second polarization component reflected by the polarizer can be entered into the first solar cell and the second solar cell respectively formed using suitable materials. Therefore, the photoelectric conversion efficiency of the first solar cell and the second solar cell is increased, and thereby, the energy regeneration efficiency in the projector can be further increased.

### Appendix 11

The projector according to Appendix 5 or 6 further includes an aperture placed between the first collection system and the first solar cell and having an opening through which the second light as the second polarization component collected by the first collection system passes, wherein the aperture blocks a light reflected by the light incident surface of the first solar cell.

According to the configuration, the aperture is provided and the reflected light of the light as the second polarization component by the light incident surface of the first solar cell can be blocked. Thereby, a defect that the reflected light of the light as the second polarization component becomes stray light, reduces the contrast of the image light, and lowers the image quality can be suppressed.

### Appendix 12

The projector according to any one of Appendix 1 to 10 further includes a second collection system placed between the liquid crystal panel and the polarizer and collecting a light output from the liquid crystal panel, wherein the second collection system is a Fresnel lens.

According to the configuration, a thickness of the second collection system in directions along an optical axis thereof is suppressed, and a dimension of the projector can be reduced.

What is claimed is:

1. A projector comprising:
a light source emitting a light;
one liquid crystal panel modulating the light emitted from the light source based on an image signal;
a polarizer reflecting a first light as a first polarization component generating an image light of the light emitted from the liquid crystal panel, and transmitting a second light as a second polarization component different from the first polarization component of the light emitted from the liquid crystal panel; and
a first solar cell entered by the second light as the second polarization component transmitted through the polarizer, wherein
the first solar cell generates electricity from the second light as the second polarization component entering from the polarizer.

2. A projector comprising:
a light source emitting a light;
one liquid crystal panel modulating the light emitted from the light source based on an image signal;
a polarizer transmitting a first light as a first polarization component generating an image light of the light emitted from the liquid crystal panel, and reflecting a second light as a second polarization component different from the first polarization component of the light emitted from the liquid crystal panel; and
a first solar cell entered by the second light as the second polarization component reflected the polarizer, wherein
the first solar cell generates electricity from the second light as the second polarization component entering from the polarizer.

3. The projector according to claim 1, wherein
the first light as the first polarization component is an S-polarized light for a light incident surface of the polarizer, and
the second light as the second polarization component is a P-polarized light for the light incident surface of the polarizer.

4. The projector according to claim 2, wherein
the first light as the first polarization component is a P-polarized light for a light incident surface of the polarizer, and
the second light as the second polarization component is an S-polarized light for the light incident surface of the polarizer.

5. The projector according to claim 1, further comprising a first collection system placed between the polarizer and the first solar cell and collecting the second light as the second polarization component transmitted through the polarizer on the first solar cell.

6. The projector according to claim 2, further comprising a first collection system placed between the polarizer and the first solar cell and collecting the second light as the second polarization component reflected by the polarizer on the first solar cell.

7. The projector according to claim 1, wherein
the first solar cell has a light incident surface entered by the second light as the second polarization component transmitted through the polarizer,
the second light as the second polarization component is a P-polarized light for the light incident surface of the first solar cell, and
the first solar cell is placed so that an angle formed by an optical axis of the second light as the second polarization component and the light incident surface is a Brewster angle.

8. The projector according to claim 2, wherein
the first solar cell has a light incident surface entered by the second light as the second polarization component reflected by the polarizer,
the second light as the second polarization component is a P-polarized light for the light incident surface of the first solar cell, and
the first solar cell is placed so that an angle formed by an optical axis of the second light as the second polarization component and the light incident surface is a Brewster angle.

9. The projector according to claim 1, further comprising:
a reflector entered by the second light as the second polarization component transmitted through the polarizer; and
a second solar cell entered by a part of the second light as the second polarization component reflected by the reflector, wherein
the reflector reflects a light in a first wavelength range of the second light as the second polarization component transmitted through the polarizer toward the first solar cell, and reflects a light in a second wavelength range different from the first wavelength range of the second light as the second polarization component transmitted through the polarizer toward the second solar cell,
first photoelectric conversion efficiency for the light in the first wavelength range of the first solar cell is higher than second photoelectric conversion efficiency for the light in the second wavelength range of the first solar cell, and
third photoelectric conversion efficiency for the light in the second wavelength range of the second solar cell is higher than fourth photoelectric conversion efficiency for the light in the first wavelength range of the second solar cell.

10. The projector according to claim 1, further comprising:
a reflector entered by the second light as the second polarization component reflected by the polarizer; and
a second solar cell entered by a part of the second light as the second polarization component reflected by the reflector, wherein
the reflector reflects a light in a first wavelength range of the second light as the second polarization component reflected by the polarizer toward the first solar cell, and reflects a light in a second wavelength range different from the first wavelength range of the second light as the second polarization component reflected by the polarizer toward the second solar cell,
first photoelectric conversion efficiency for the light in the first wavelength range of the first solar cell is higher than second photoelectric conversion efficiency for the light in the second wavelength range of the first solar cell, and
third photoelectric conversion efficiency for the light in the second wavelength range of the second solar cell is higher than fourth photoelectric conversion efficiency for the light in the first wavelength range of the second solar cell.

11. The projector according to claim 5, further comprising an aperture placed between the first collection system and the first solar cell and having an opening through which the second light as the second polarization component collected by the first collection system passes, wherein
the aperture blocks a light reflected by the light incident surface of the first solar cell.

12. The projector according to claim 1, further comprising a second collection system placed between the liquid crystal panel and the polarizer and collecting a light output from the liquid crystal panel, wherein
the second collection system is a Fresnel lens.
